(19) United States
(12) Patent Application Publication
(10) Pub. No.: US 2007/0014556 A1
(43) Pub. Date: Jan. 18, 2007

(54) Communications devices including integrated digital cameras operating at different frequencies and related methods

(76) Inventor: Truls Persson, Sodra Sandby (SE)

Correspondence Address: MYERS BIGEL SIBLEY & SAJOVEC, P.A., P.O. BOX 37428, RALEIGH, NC, 27627, US

(21) Appl. No.: 11/182,373

(22) Filed: Jul. 15, 2005

(51) Int. Cl. G03B 17/00

(52) U.S. Cl. 396/57

(57) ABSTRACT

A communications device may include a receiver, a tunable clock signal generator, a digital camera, and a processor. The receiver may be configured to receive communications over an air interface using a plurality of frequency channels. The tunable clock signal generator may be configured to generate a tunable clock signal responsive to a tuning input. The digital camera may be configured to capture digital images and to operate responsive to the tunable clock signal. The processor may be coupled to the receiver, the tunable clock signal generator, and the digital camera. Moreover, the processor may be configured to determine at least one of the plurality of frequency channels over which communications are likely to be received and to generate the tuning input for the tunable clock signal generator responsive to determining the at least one of the plurality of frequency channels over which communications are likely to be received. Related methods are also discussed.

### FIELD OF THE INVENTION

The present invention relates to the field of electronics, and more particularly, to communications devices including integrated digital cameras and related methods.

### BACKGROUND

The integration of a digital camera into a cellular radiotelephone has become common. Typically, a chip set for the digital camera functionality is provided separate from the components providing radiotelephone functionality. More particularly, a digital signal processor (DSP) may be provided for the digital camera functionality separate from a central processor unit (CPU) providing and/or coordinating other functionalities of the camera/phone.

Moreover, a system clock for the camera phone may provide a system clock signal (such as a 13 MHz clock signal) that is used by the CPU, the digital camera, and a transceiver for the radiotelephone. The camera chip set may include a phase-locked-loop (PLL) that uses the system clock signal to generate a higher frequency camera clock signal (for example, having a frequency of approximately 100 MHz), and the camera clock signal may be used to operate the camera DSP and/or an optical sensor of the digital camera.

The camera clock signal, however, may include harmonic components that interfere with radiotelephone frequencies received at the radiotelephone transceiver. In a GSM radiotelephone, for example, the radiotelephone transceiver may transmit communications to a base station at frequencies in the range of 1850 MHz to 1910 MHz, and the radiotelephone transceiver may receive communications from the base station at frequencies in the range of 1930 MHz to 1990 MHz. More particularly, harmonic components of the camera clock signal may interfere with reception of communications at frequencies in the range of 1930 MHz to 1990 MHz at the radiotelephone transceiver.

Accordingly, electromagnetic shielding may be used to shield the radiotelephone transceiver from interference generated by the camera clock signal. For example, the chip set for the digital camera functionality may be provided within a shielded enclosure. It may be difficult, however, to provide adequate shielding around the chip set for the digital camera functionality because it may not be possible to completely enclose the chip set. For example, at least a lens of the digital camera may require an opening in the electromagnetic shielding to allow operation thereof.

In an alternative, the central processor may block operation of radiotelephone communications when the digital camera is being used, and/or the central processor may block operation of the digital camera during radiotelephone communications. This alternative, however, may undesirably limit operation of camera and/or radiotelephone functionalities. Moreover, use of the camera may result in missed communications initiated by others (such as incoming radiotelephone calls, text messages, SMS messages, etc.), and/or missed roaming and/or location updates.

Accordingly, there continues to exist a need in the art for improved methods and systems that reduce interference between digital cameras and transceivers in integrated camera/phone devices.

### SUMMARY

According to some embodiments of the present invention, a communications device may include a receiver, a tunable clock signal generator, a digital camera, and a central processor. The receiver may be configured to receive communications over an air interface using a plurality of frequency channels, and the tunable clock signal generator may be configured to generate a tunable clock signal responsive to a tuning input. The digital camera may be configured to capture digital images and to operate responsive to the tunable clock signal. The central processor may be coupled to the receiver, the tunable clock signal generator, and the digital camera. Moreover, the central processor may be configured to determine at least one of the plurality of frequency channels over which communications are likely to be received and to generate the tuning input for the tunable clock signal generator responsive to determining the at least one of the plurality of frequency channels over which communications are likely to be received.

More particularly, the tunable clock signal generator may include a voltage controlled oscillator, and/or the central processor may be configured to receive an identification of the at least one of the plurality of frequency channels from a base station through the receiver. The central processor may also be configured to generate the tuning input for the tunable clock signal generator so that interference from the digital camera is reduced with respect to the at least one of the plurality of frequency channels over which communications are likely to be received.

The central processor may be configured to determine a first frequency channel over which communications are likely to be received at a first time and to generate a first tuning input for the tunable clock signal generator responsive to determining the first frequency channel. The central processor may also be configured to determine a second frequency channel over which communications are likely to be received at a second time and to generate a second tuning input for the tunable clock signal generator responsive to determining the second frequency channel. Moreover, the first and second frequency channels may be different, and the first and second tuning inputs may be different. More particularly, the tunable clock signal generator may be configured to generate a first tunable clock signal having a first frequency responsive to the first tuning input and to generate a second tunable clock signal having a second frequency responsive to the second tuning input, and the first and second frequencies may be different.

The digital camera may include a camera clock signal generator configured to generate a camera clock signal responsive to the tunable clock signal, and the camera clock signal generator may be a phase-locked-loop (PLL). In addition, a frequency of the camera clock signal may be greater than a frequency of the tunable clock signal. Moreover, the digital camera may include a digital signal processor coupled to the clock signal generator and an optical sensor coupled to the digital signal processor. The optical sensor may be configured to convert an optical image to an electrical signal, and the digital signal processor may be configured to process the electrical signal using the camera clock signal. The communications device may also include a transmitter coupled to the central processor, the transmitter may be configured to transmit communications over the air interface, and the central processor may be configured to process the communications transmitted and received over the air interface.

According to other embodiments of the present invention, methods may be provided for operating a communications device including a digital camera configured to capture a digital image and a receiver configured to receive communications over an air interface using a plurality of frequency bands. At least one of the plurality of frequency channels over which communications are likely to be received may be determined, and a tunable clock signal may be generated responsive to determining the at least one of the plurality of frequency channels over which communications are likely to be received. Accordingly, the digital camera may be operated using the tunable clock signal.

Generating the tunable clock signal may include generating a tunable clock signal input and providing the tunable clock signal input to a voltage controlled oscillator. In addition, determining at least one of the plurality of frequency channels over which communications are likely to be received may include receiving an identification of the at least one of the plurality of frequency channels from a base station through the receiver. Moreover, generating the tunable clock signal may include generating the tunable clock signal so that interference from the digital camera with respect to the at least one of the plurality of frequency channels over which communications are likely to be received is reduced.

Determining the at least one of the plurality of frequency channels may include determining a first frequency channel over which communications are likely to be received at a first time and determining a second frequency channel over which communications are likely to be received at a second time. In addition, generating the tunable clock signal may include generating a first tunable clock signal having a first frequency at the first time and generating a second tunable clock signal having a second frequency at the second time. Moreover, the first and second frequencies may be different.

Operating the digital camera may include generating a camera clock signal responsive to the tunable clock signal. For example, the camera clock signal may be generated using a phase-locked-loop (PLL). Moreover, a frequency of the camera clock signal may be greater than a frequency of the tunable clock signal. In addition, operating the digital camera may include converting an optical image to an electrical signal and processing the electrical signal using the camera clock signal. Furthermore, communications may be transmitted from the communications device over the air interface.

According to still additional embodiments of the present invention, a communications device may include a receiver, a digital camera, and a central processor coupled to the receiver and digital camera. The receiver may be configured to receive communications over an air interface, and the digital camera may be configured to capture digital images and to operate at different frequencies responsive to a frequency tuning input. The central processor may be configured to process communications received through the receiver and to generate a first frequency tuning input so that the digital camera operates at a first frequency. After generating the first frequency tuning input, the central processor may be configured to generate a second frequency tuning input so that the digital camera operates at a second frequency. Moreover, the first and second frequencies may be different.

### BRIEF DESCRIPTION OF THE DRAWINGS

FIG. 1 is a block diagram illustrating communications devices according to embodiments of the present invention.

FIG. 2 is a flow chart illustrating operations of communications devices according to embodiments of the present invention.

### DETAILED DESCRIPTION

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawing, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defmed herein.

It will be understood that although the terms first and second are used herein to describe various elements, these elements should not be limited by these terms. These terms are only used to distinguish one element from another element. Thus, a first frequency below could be termed a second frequency, and similarly, a second frequency may be termed a first frequency without departing from the teachings of the present invention. As used herein, the term “and/or” includes any and all combinations of one or more of the associated listed items. The symbol “/” is also used as a shorthand notation for “and/or”.

Various embodiments of the present invention are described below with reference to block diagrams and/or operational illustrations (e.g., flowcharts) illustrating methods, apparatus and computer program products according to various embodiments of the invention. It will be understood that each block of the block diagrams and/or operational illustrations, and combinations of blocks in the block diagrams and/or operational illustrations, can be implemented by analog and/or digital hardware, and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational illustrations. Accordingly, it will be appreciated that the block diagrams and operational illustrations support apparatus, methods and computer program products.

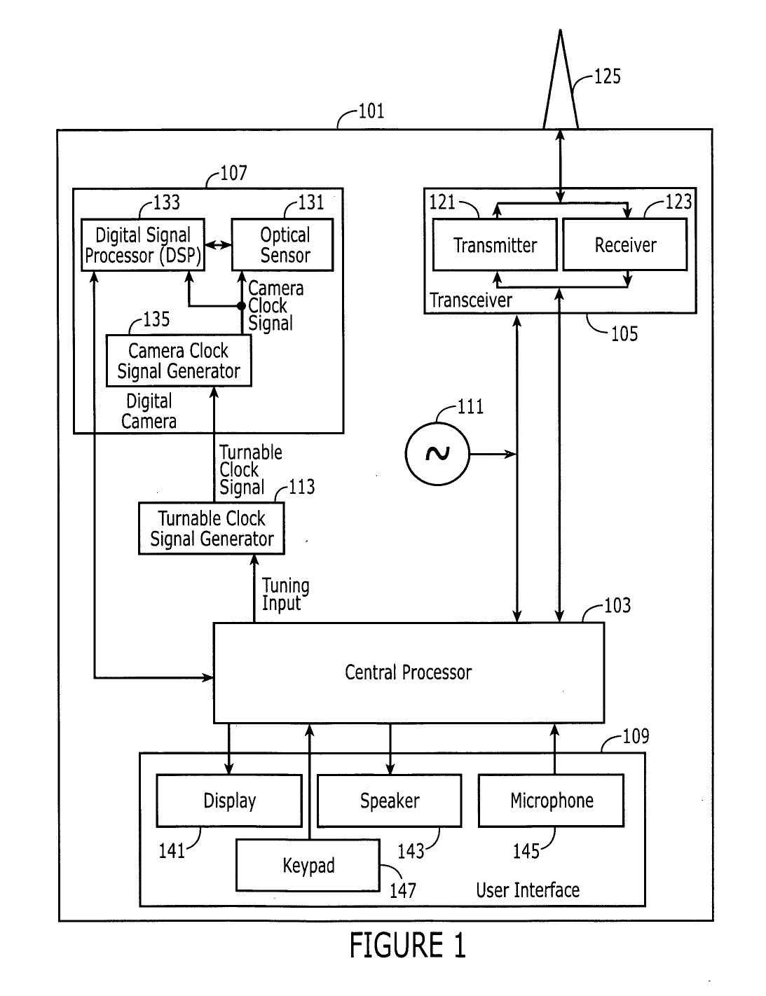

Communications devices according to embodiments of the present invention are illustrated in FIG. 1. As shown in FIG. 1, a communications device 101 may include a central processor 103 (such as a central processing unit or CPU), a transceiver 105, a digital camera 107, a user interface 109, a fixed frequency clock signal generator 111, and a tunable clock signal generator 113. The transceiver 105 may include a transmitter 121 and a receiver 123 coupled to an antenna 125. The digital camera 107 may include an optical sensor 131, a digital signal processor 133, and a camera clock signal generator 135, and the user interface 109 may include a display 141, a speaker 143, a microphone 145, and a keypad 147. More particularly, the tunable clock signal generator 113 may be a voltage controlled oscillator (VCO), and the camera clock signal generator 135 may be a phase-locked-loop (PLL).

Accordingly, the central controller 103 and the transceiver 105 may operate to transmit and/or receive radio communications over an air interface using a system clock signal generated by the fixed frequency clock signal generator 111. The system clock signal, for example, may have a frequency of about 13 MHz. More particularly, the transmitter 121 may be configured to transmit communications generated by the central processor 103 using one of a plurality of uplink frequency channels of an air interface, and the receiver 123 may be configured to receive communications using one of a plurality of downlink frequency channels of the air interface. By way of example, the GSM air interface may provide a plurality of 1 kHz wide uplink frequency channels (for transmissions from a mobile terminal to a base station) over an uplink frequency band in the range of about 1850 MHz to about 1910 MHz and a plurality of 1 kHz wide downlink frequency channels (for transmissions from a base station to a mobile terminal) over an downlink frequency band in the range of about 1930 MHz to about 1990 MHz.

In a cellular communications network, a plurality of fixed radiotelephone base stations may provide communications for respective geographic areas (also referred to as cells). By providing that adjacent base stations are allocated use of different uplink and downlink frequency channels according to a frequency reuse pattern, interference between base stations can be reduced, and a capacity of the communications network can be increased. Accordingly, each base station may be allocated a sub-set of the downlink frequency channels for transmissions to mobile terminals and a sub-set of the uplink frequency channels for reception from the mobile terminals in the respective geographic area. Each base station may transmit control information within the respective geographic area identifying the sub-sets of uplink and down-link frequency channels being used by the base station. In addition or in an alternative, a base station may assign uplink and downlink frequency channels to the communications device 101 when a communications link is established.

A transceiver of a communications device within the geographic area receiving the control information can thus tune to the appropriate uplink and/or down-link frequency channel(s) and/or the appropriate control frequency channel(s). Accordingly, the central processor 103 of the communications device 101 can determine particular frequency channels that are likely to be used, and the particular frequency channels that are likely to be used will change as the communications device 101 moves from one base station to another. More particularly, the control processor 103 can determine one or a plurality of the down-link frequency and/or control channels that are likely to be used for reception at the receiver 123.

During a radiotelephone voice communication, for example, a particular uplink frequency channel and a particular downlink frequency channel may be assigned to the communications device 101. A voice signal generated by the microphone 145 may be processed by the central processor 103 and transmitted using the transmitter 121 and the antenna 125 on the assigned uplink frequency channel. Voice information from a distant party may be received on the assigned downlink frequency channel using the antenna 125 and receiver 123, processed using central processor 103, and output on speaker 143. In addition or in an alternative, text messages (such as SMS messages) may be transmitted and/or received, and/or network browsing operations may be provided. Moreover, control information may be received over a downlink control frequency channel(s).

The digital camera 107 may be configured to capture digital images. More particularly, the optical sensor 131 may be configured to convert an optical image to an electrical signal, and the digital signal processor 133 may be configured to process the electrical signal from the optical sensor 131 to provide a digital image. The digital signal processor 133 and/or the optical sensor 131 may operate using the camera clock signal generated by the camera clock signal generator 135. More particularly, the camera clock signal may be generated by the camera clock signal generator 135 using the tunable clock signal generated by the tunable clock signal generator 113 so that a frequency of the camera clock signal is a function of a frequency of the tunable clock signal and so that the frequency of the camera clock signal is greater than a frequency of the tunable clock signal. Accordingly, different frequencies of the tunable clock signal (controllable by a tuning input provided from the central processor 103 to the tunable clock signal generator 113) may result in corresponding different frequencies of the camera clock signal. For example, the camera clock signal may have a frequency that is about 1 order of magnitude (or more) greater than a frequency of the tunable clock signal. For example, the tunable clock signal may have a frequency in the range of about 10 MHz to about 15 MHz, and the camera clock signal may have a frequency in the range of about 90 MHz to about 110 MHz.

A digital image from the digital signal processor 133 may be stored in memory in the digital camera 107 and/or in memory in the central processor 103. In addition or in an alternative, a digital image from the digital signal processor 133 and/or from memory may be processed by central processor 103 and transmitted over the air interface using the transmitter 121 and antenna 125.

Harmonic components of the camera clock signal generated by the camera clock signal generator 135 may interfere with some downlink frequency channels of a given air interface. Not all downlink frequency channels of the air interface, however, are equally likely to be received at a given time. According to some embodiments of the present invention, the central processor 103 may thus be configured to determine at least one of the plurality of downlink frequency channels over which communications are more likely to be received and to generate a tuning input for the tunable clock signal generator 113 so that interference from the digital camera 107 (and more particularly from the camera clock signal generated by the camera clock signal generator 135) is reduced with respect to the at least one of the plurality of downlink frequency channels over which communications are likely to be received.

When initially turned on, the central processor 103 and/or receiver 123 may scan for a control frequency channel transmitted by a base station providing service for the cell within which the communications device 101 is located. Once the control frequency channel is identified, the central processor 103 can generate the tuning input for the tunable clock signal generator 113 to provide that interference from the camera clock signal (generated by the camera clock signal generator 135) is reduced with respect to the identified control frequency channel. Moreover, information provided on the control frequency channel may identify a sub-set of downlink frequency channels used by the base station for voice communications, text messaging, internet browsing, etc. Accordingly, the central processor 103 can generate the tuning input for the tunable clock signal generator 113 to provide that interference from the camera clock signal (generated by the camera clock signal generator 135) is reduced with respect to the identified control frequency channel and/or sub-set of other identified downlink frequency channels that are likely to be received at receiver 123.

In addition or in an alternative, the base station may identify a particular downlink frequency channel to be used by the receiver 123 when a communication (such as a radiotelephone voice communication) is established with the communications device 101. While establishing the communication, the central processor 103 may thus generate a new (i.e., different) tuning input for the tunable clock signal generator 113 to provide that interference from the camera clock signal (generated by the camera clock signal generator 135) is reduced with respect to the particular downlink frequency channel for the communication being established. Once the communication is ended, the central processor 103 may again apply the earlier tuning input to reduce interference with respect to the control frequency channel.

When the communications device 101 is moved to a second cell serviced by a second base station, the central processor 103 and/or receiver 123 may scan for a second control frequency channel transmitted by the second base station. Once the second control frequency channel is identified, the central processor 103 can generate another tuning input for the tunable clock signal generator 113 to provide that interference from the camera clock signal (generated by the camera clock signal generator 135) is reduced with respect to the second control frequency channel from the second base station. Moreover, information provided on the second control frequency channel may identify a second sub-set of downlink frequency channels used by the base station for voice communications, text messaging, internet browsing, etc. Accordingly, the central processor 103 can generate the second tuning input for the tunable clock signal generator 113 to provide that interference from the camera clock signal (generated by the camera clock signal generator 135) is reduced with respect to the second identified control frequency channel and/or the second sub-set of identified downlink frequency channels that are likely to be received at receiver 123.

Accordingly, a frequency of the camera clock signal (generated by the camera clock signal generator 135) may change when the communications device 101 switches from service with one base station to service with another base station, when a communication session (such as a voice radiotelephone communication, a text message session, a network browsing session, etc.) is initiated or terminated, etc. By way of example, interference with downlink frequency channels of an air interface generated by the digital camera 107 using different tuning inputs, different tunable clock signal frequencies, and/or different camera clock signal frequencies may be characterized. Accordingly, a correlation of tuning inputs with respect to downlink frequency channel interference may be provided, and the central processor 103 can use this table to provide an appropriate tuning input responsive to determining the frequency channel(s) over which communications are likely to be received at the receiver 123. Accordingly, interference from the digital camera 107 may be reduced with respect to operations of the receiver 123.

Interference from the digital camera 107 in the downlink frequency band may thus be tuned to reduce interference with respect to downlink frequency channels currently being used (or likely to be used) by the communications device. Stated in other words interference from the digital camera 107 in the downlink frequency band may be tuned to downlink frequency channels not currently being used (or not likely to be used) by the communications device.

As discussed above, the tunable clock signal generator 113 may be a voltage controlled oscillator (VCO). More particularly, the tunable clock signal generator 113 may be a voltage controlled crystal oscillator (VCXO), and the frequency of the tunable clock signal generated by the VCXO may be controlled by providing the tuning input at different voltage levels corresponding to different frequencies. For example, the tuning input can be generated by a digital-to-analog converter (DAC) included in the central processor 103, with different digital inputs to the DAC being used to provide corresponding different frequencies for the tunable clock signal and corresponding different frequencies for the camera clock signal.

While the tunable clock signal generator 113 is illustrated as being separate from the digital camera 107 and the camera clock signal generator 135, the tunable clock signal generator 113 may be included as a component of the digital camera 107 and/or the camera clock signal generator 135. Accordingly, separate tunable clock signal and camera clock signal generators may not be required. In an alternative, functionalities of the camera clock signal generator 135 and the tunable clock signal generator 113 may both be provided outside the digital camera 107 and/or combined.

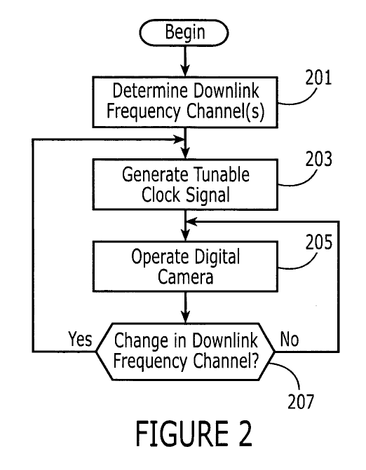

FIG. 2 is a flow chart illustrating operations of communications devices according to embodiments of the present invention. At block 201, the central processor 103 and/or receiver 123 may determine one or a plurality of frequency channels (such as downlink and/or control frequency channels) over which communications are likely to be received. For example, frequency channel information may be provided by a network base station servicing the cell in which the communications device is located.

At block 203, a tunable clock signal may be generated with a frequency of the tunable clock signal being determined based on the frequency channel(s) over which communications are likely to be received. At block 205, operation of the digital camera 107 may proceed using the tunable clock signal. As discussed above, a camera clock signal may be generated within the digital camera with a frequency of the camera clock signal being a function of the tunable clock signal and with the frequency of the camera clock signal being greater than the frequency of the tunable clock signal. By generating the tunable clock signal responsive to determining the frequency channel(s) over which communications are likely to be received, interference from the digital camera can be reduced with respect to communications received at the communications device.

At block 207, the communications device may monitor for changes in frequency channels that are likely to be used for communications received at the communications device. A change may occur for example, when the communications device is moved to a new cell serviced by a new base station, and/or when a particular downlink frequency channel is assigned for a communications session for the communications device. As long as there is no change, the digital camera may continue operation using the same tunable clock signal frequency. When there is a change at block 207, the tunable clock signal may be generated with a new frequency at block 203, and operations of the digital camera may proceed at block 205 using the tunable clock signal at the new frequency.

Accordingly, the digital camera may operate at different frequencies at different times to reduce interference with particular frequency channels that are likely to be received at different times. The digital camera can thus be used during a radiotelephone voice communication with reduced interference. Moreover, a likelihood of missing an incoming call request, an incoming text message, etc. while using the digital camera may be reduced.

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A communications device including:
a receiver configured to receive communications over an air interface using a plurality of frequency channels;
a tunable clock signal generator configured to generate a tunable clock signal having a frequency that varies responsive to a tuning input;
a digital camera configured to capture digital images, the digital camera being configured to operate responsive to the tunable clock signal; and
a processor coupled to the receiver, the tunable clock signal generator, and the digital camera, the processor being configured to determine at least one of the plurality of frequency channels over which communications are likely to be received and to generate the tuning input for the tunable clock signal generator responsive to determining the at least one of the plurality of frequency channels over which communications are likely to be received.

2. A communications device according to claim 1 wherein the tunable clock signal generator comprises a voltage controlled oscillator.

3. A communications device according to claim 1 wherein the processor is configured to receive an identification of the at least one of the plurality of frequency channels from a base station through the receiver.

4. A communications device according to claim 1 wherein the processor is configured to generate the tuning input for the tunable clock signal generator so that interference from the digital camera with respect to the at least one of the plurality of frequency channels over which communications are likely to be received is reduced.

5. A communications device according to claim 1 wherein the processor is configured to determine a first frequency channel over which communications are likely to be received at a first time and to generate a first tuning input for the tunable clock signal generator responsive to determining the first frequency channel and to determine a second frequency channel over which communications are likely to be received at a second time and to generate a second tuning input for the tunable clock signal generator responsive to determining the second frequency channel, wherein the first and second frequency channels are different and wherein the first and second tuning inputs are different.

6. A communications device according to claim 5 wherein the tunable clock signal generator is configured to generate a first tunable clock signal having a first frequency responsive to the first tuning input and to generate a second tunable clock signal having a second frequency responsive to the second tuning input, wherein the first and second frequencies are different.

7. A communications device according to claim 1 wherein the digital camera includes a camera clock signal generator configured to generate a camera clock signal responsive to the tunable clock signal.

8. A communications device according to claim 7 wherein the camera clock signal generator comprises a phase-locked-loop (PLL).

9. A communications device according to claim 7 wherein a frequency of the camera clock signal is greater than a frequency of the tunable clock signal.

10. A communications device according to claim 7 wherein the digital camera includes a digital signal processor coupled to the clock signal generator and an optical sensor coupled to the digital signal processor wherein the optical sensor is configured to convert an optical image to an electrical signal and wherein the digital signal processor is configured to process the electrical signal using the camera clock signal.

11. A communications device according to claim 1 further comprising:
a transmitter coupled to the processor, wherein the transmitter is configured to transmit communications over the air interface and wherein the processor is configured to process the communications transmitted and received over the air interface.

12. A method of operating a communications device including a digital camera configured to capture a digital image and a receiver configured to receive communications over an air interface using a plurality of frequency bands, the method including:
determining at least one of the plurality of frequency channels over which communications are likely to be received;
generating a tunable clock signal responsive to determining the at least one of the plurality of frequency channels over which communications are likely to be received; and
operating the digital camera using the tunable clock signal.

13. A method according to claim 12 wherein generating the tunable clock signal includes generating a tunable clock signal input, and providing the tunable clock signal input to a voltage controlled oscillator.

14. A method according to claim 12 wherein determining at least one of the plurality of frequency channels over which communications are likely to be received includes receiving an identification of the at least one of the plurality of frequency channels from a base station through the receiver.

15. A method according to claim 12 wherein generating the tunable clock signal comprises generating the tunable clock signal so that interference from the digital camera with respect to the at least one of the plurality of frequency channels over which communications are likely to be received is reduced.

16. A method according to claim 12 wherein determining the at least one of the plurality of frequency channels comprises determining a first frequency channel over which communications are likely to be received at a first time and determining a second frequency channel over which communications are likely to be received at a second time, and wherein generating the tunable clock signal comprises generating a first tunable clock signal having a first frequency at the first time and generating a second tunable clock signal having a second frequency at the second time wherein the first and second frequencies are different.

17. A method according to claim 12 wherein operating the digital camera comprises generating a camera clock signal responsive to the tunable clock signal.

18. A method according to claim 17 wherein generating the camera clock signal comprises generating the camera clock signal using a phase-locked-loop (PLL).

19. A method according to claim 17 wherein a frequency of the camera clock signal is greater than a frequency of the tunable clock signal.

20. A method according to claim 17 wherein operating the digital camera comprises converting an optical image to an electrical signal and processing the electrical signal using the camera clock signal.

21. A method according to claim 12 further comprising:
transmitting communications over the air interface.

22. A communications device including:
a receiver configured to receive communications over an air interface;
a digital camera configured to capture digital images, the digital camera being configured to operate at different frequencies responsive to a frequency tuning input; and
a processor coupled to the receiver and the digital camera, wherein the processor is configured to process communications received through the receiver and wherein the processor is configured to generate a first frequency tuning input so that the digital camera operates at a first frequency, and wherein after generating the first frequency tuning input the processor is configured to generate a second frequency tuning input so that the digital camera operates at a second frequency, wherein the first and second frequencies are different.
